(19) United States
(12) Patent Application Publication
(10) Pub. No.: US 2016/0290940 A1
(43) Pub. Date: Oct. 6, 2016

(54) SYSTEM AND METHOD FOR CHEMICALLY AUTHENTICATING ITEMS

(71) Applicant: Indiana University Research and Technology Corporation, Indianapolis, IN (US)

(72) Inventor: Kasem K. Kasem, Kokomo, IN (US)

(73) Assignee: Indiana University Research and Technology Corporation, Indianapolis, IN (US)

(21) Appl. No.: 15/087,399

(22) Filed: Mar. 31, 2016

Related U.S. Application Data
(60) Provisional application No. 62/141,561, filed on Apr. 1, 2015.

(51) Int. Cl. G01N 23/223

(52) U.S. Cl. CPC G01N 23/223

(57) ABSTRACT

A system and method are provided for authenticating an item, comprising selecting a coding site on the item, storing a location of the coding site, selecting a coding material including at least one transition metal, obtaining an original spectrum of the coding material using an X-ray fluorescence spectroscopy device, storing the original spectrum, applying the coding material to the coding site, and authenticating the item. The item is authenticated by accessing the location of the coding site and the original spectrum, obtaining an authentication spectrum of the coding material using an X-ray fluorescence spectroscopy device, and comparing the authentication spectrum to the original spectrum. The item is authentic when the coding material is present at the coding site and the authentication spectrum matches the original spectrum. The item is not authentic when the coding material is not present at the coding site or the spectra do not match.

### CROSS-REFERENCE TO RELATED APPLICATIONS

This application claims priority to U.S. Provisional Patent Application Ser. No. 62/141,561, filed Apr. 1, 2015, the disclosure of which is expressly incorporated herein by reference in its entirety.

### TECHNICAL FIELD

The present invention relates generally to authentication techniques and more particularly to systems and methods for authenticating items by verifying a spectrum of a chemical code applied to or embedded in the item.

### BACKGROUND

Valuable and/or rare items such as artifacts, antiquities, artwork, relics, etc. are common targets for thieves. Such items are often housed in museums or other secured locations periodically opened to the public. If a thief gains access to the location, either illegally or as part of the thief's employment by the secured location, the thief may take an original item (or portion thereof) and replace it with a replica to avoid detection of the theft. Such items are also often moved to new locations for display. During transportation of the items, thieves may similarly steal an item (or portion thereof) and replace it with a replica to avoid detection of the theft. If the quality of the replicas is very high, it may be essentially impossible to authenticate the items and detect such instances of theft.

Some anti-counterfeiting techniques have been developed to inhibit the above-described theft and forgery. Conventional techniques include the application of organic material to the original items in a manner that is invisible to potential thieves. This type of coding may be detected using Raman spectroscopy. Unfortunately, organic materials have relatively short shelf-lives and decompose. Many artifacts are intended to be maintained indefinitely, so a coding technique that evaporates in a relatively short time period is unacceptable. When the coding evaporates, the item becomes more susceptible to theft. Another conventional alternative is digital tagging. However, if the thieves are capable of replicating the digital tag, the thieves can successfully steal the original item and tag the replica.

Accordingly, there exists a need for an authentication technique that remains effective for hundreds of years, is nearly impossible for thieves to identify and also nearly impossible for thieves to duplicate.

### SUMMARY

In one embodiment, the present disclosure provides a method for authenticating an item, comprising selecting a coding site on the item, storing a location of the coding site, selecting a coding material including at least one transition metal, obtaining an original spectrum of the coding material using an X-ray fluorescence spectroscopy device, storing the original spectrum, applying the coding material to the coding site and authenticating the item. The item is authenticated by accessing the location of the coding site and the original spectrum, determining whether the coding material is present at the coding site, obtaining an authentication spectrum of the coding material using an X-ray fluorescence spectroscopy device, comparing the authentication spectrum to the original spectrum, classifying the item as authentic when the coding material is present at the coding site and the authentication spectrum matches the original spectrum, and classifying the item as not authentic when the coding material is not present at the coding site or the authentication spectrum does not match the original spectrum.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a perspective view of an item for authentication;

FIG. 2 is a flow diagram of a method for authenticating an item according to the principles of the present disclosure; and

FIG. 3 is a spectrum emitted by an item coded according to the principles of the present disclosure.

While the present disclosure is amenable to various modifications and alternative forms, specific embodiments have been shown by way of example in the drawings and are described in detail below. The present disclosure, however, is not to limit the particular embodiments described. On the contrary, the present disclosure is intended to cover all modifications, equivalents, and alternatives falling within the scope of the appended claims.

### DETAILED DESCRIPTION

As used herein, the term “item” refers to any object, including objects having value as a consequence of their rarity, age, manufacturing source, cultural and/or historical significance, etc. Non-limiting examples of such items include works of art (e.g., sculptures, paintings, drawings, textiles, pottery, jewelry, etc.), utensils, weapons, currency, musical instruments, clothing, skeletons, books, and astronomical artifacts. Such items are frequently targeted by thieves because of their value. Perhaps the most effective way for such thieves to avoid punishment for their crime is to conceal the fact that a crime was committed. By replacing the stolen original item with a high quality replica, the thieves may prevent the owner or custodian of the item from detecting its theft. The authentication method provided herein addresses this concern.

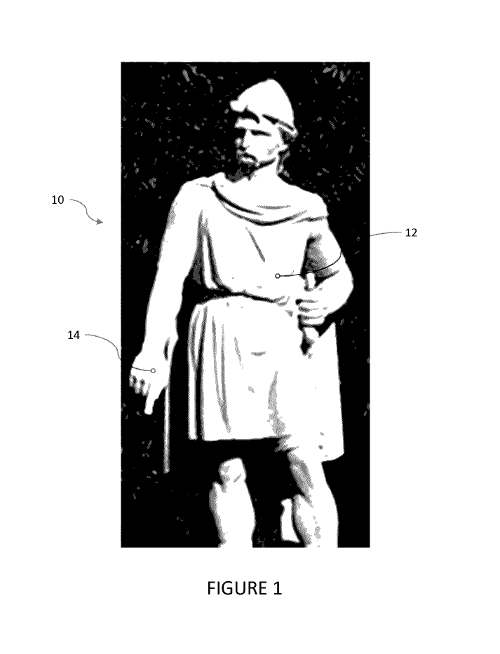

Referring now to FIG. 1, an item 10 is shown. As shown, item 10 has two coding sites 12, 14 as is further described below. In many instances, only one coding site is needed to authenticate the item. In some instances, however, multiple coding sites may be used because it is conceivable that portions of the item may be stolen. For example, when it is difficult for thieves to steal an entire item because of its size or weight, the thieves may steal an appendage of the item, such as an arm or hand in the case of item 10, which may have substantial value on the black market. The thieves may then attach a replica appendage to reduce the possibility that the theft will be detected. Thus, in the example depicted in FIG. 1, coding site 14 is selected to permit authentication of the hand and arm of item 10. Coding site 12 is selected to permit authentication of item 10 generally.

As is further described below, chemical coding material is applied to or embedded in coding sites 12, 14 for later authentication using x-ray fluorescence spectroscopy. As the chemical coding material is visually imperceptible, the location of coding sites 12, 14 is recorded and stored by a trusted authority. When item 10 is authenticated, part of the authentication is verification that the coding sites 12, 14 are in the proper location. As such, even if a thief somehow gained access to the coding material, the thief could not code a replica item and inhibit detection of the theft without also knowing the correct location of the coding site(s).

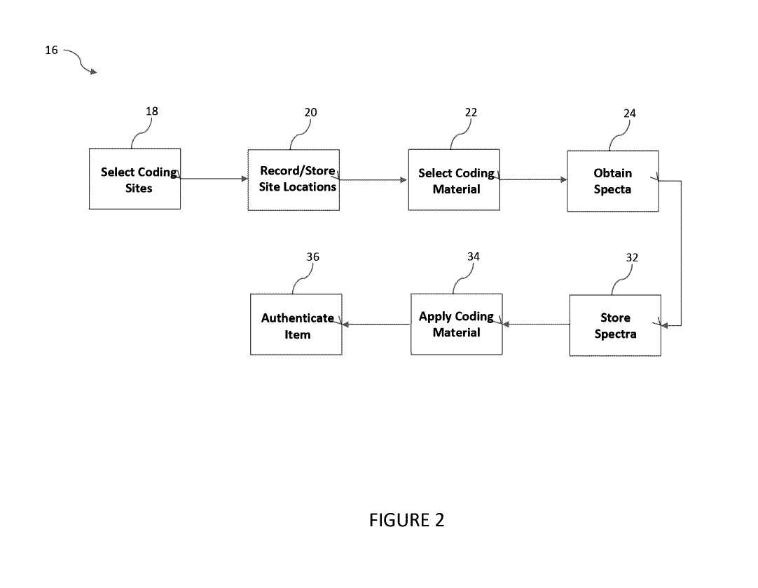

Referring now to FIG. 2, a process 16 for chemically authenticating items is shown. At step 18, one or more coding site locations are selected. As explained above, multiple coding sites may be used to permit authentication of portions of the item. In certain embodiments, even though the coding sites are essentially invisible, the coding sites are located in an inconspicuous or less prominent area of the item so as to minimize the possibility of damage to the item. At step 20, the location(s) of the coding site(s) is/are recorded and stored by a trusted authority. The trusted authority, in certain embodiments, may be a security firm, a governmental agency, or the owner or custodian of the item. As will be understood by those skilled in the art, often thefts are perpetrated by persons or organizations having responsibility for the care and maintenance of items (i.e., “inside jobs”). For this reason, the owner or custodian of the item may often not be the desired trusted authority.

At step 22, a chemical coding material is selected. Of course, step 22 may precede steps 18 and 20, and in general many of the steps of process 16 may be performed in a different order. In one embodiment, the coding material comprises one or more heavy-transition metals (groups 3 through 12 on the periodic table), and in particular rare-earth metals which have exceptional stability and may remain intact for thousands of years. In other embodiments, other chemical elements may be used. As is known in the art, rare-earth metals can be detected using x-ray fluorescence spectroscopy, and each element emits a different characteristic spectrum when excited by bombarding the element with high energy x-rays across a range of energy levels. As the equipment for performing such detection is very expensive, the use of this technology for coding according to the principles of the present disclosure further inhibits the ability of thieves from attempting to replicate the coding. Combinations of chemical elements may be used as the coding material, and such combinations result in unique spectra that are difficult to duplicate without knowing the precise chemical composition of the combination. Use of such combinations, therefore, provides further security to the overall authentication process.

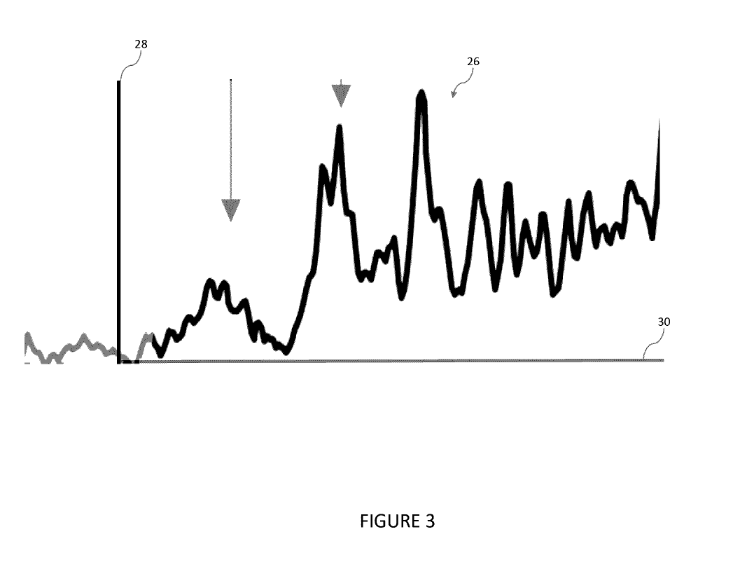

After a coding material is selected, a spectrum of the material is obtained at step 24 using one of a variety of different detection devices such as the handheld X-ray fluorescent analyzers manufactured by Bruker Corporation. FIG. 3 depicts a sample spectrum 26. Spectrum 26 has characteristic excitation intensities (y-axis 28) across the range of X-ray energy levels (x-axis 30) applied to the coding material. The spectrum 26 is unique to the chemical composition used as the coding material, may be repeatedly detected with a high degree of accuracy, and provides a reliable “finger-print” when applied to or embedded in item 10.

The obtained spectrum is then stored by the trusted authority at step 32. At step 34, the coding material is applied to or embedded in item 10. This step may be carried out in a variety of ways, primarily depending upon the composition of item 10. In the example of a statue made of metal or stone, a small bore (e.g., 1 mm diameter) may be formed in the item and filled with the coding material. In many embodiments, the coding material is colored or tinted to match precisely the color of the original material at the coding site. In this manner, the coding material will be visually imperceptible. For other items such as paintings, the coding material is applied as a paint colored or tinted to match the original paint at the coding site. For textiles, the coding material may be applied to the fiber to match the original color. In other embodiments, the coding material is prepared to be transparent and colorless, and can be applied at any location on the item.

Step 36 of FIG. 2 represents the authentication of item 10. In this step, the party authenticating item 10 obtains the location information for the coding site(s) and the original spectrum from the trusted authority. The authenticating party then scans item 10 at the coding site(s) to obtain an authentication spectrum and compares the authentication spectrum to the original spectrum. If the spectra match, then the item is authentic. If, on the other hand, coding material is not present at the coding site locations, or the spectrum of the coding material does not match the original spectrum, then the item is a replica.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

I claim:

1. A method for authenticating an item, the method comprising:
applying a coding material to a coding site on the item, the coding material including at least one transition metal and having an x-ray fluorescence spectrum;
obtaining an authentication spectrum at the coding site using an X-ray fluorescence spectroscopy device; and
authenticating the item by classifying the item as authentic when the coding material is present at the coding site and the authentication spectrum matches the x-ray fluorescence spectrum of the coding material and classifying the item as not authentic when the coding material is not present at the coding site or the authentication spectrum does not match the x-ray fluorescence spectrum of the coding material.

2. The method of claim 1, wherein the at least one transition metal is selected from a transition metal in groups 3 through 12 of the periodic table.

3. The method of claim 2, wherein the at least one transition metal is a rare-earth metal.

4. The method of claim 1, wherein the coding material includes a combination of chemical elements, the combination of chemical elements resulting in the authentication spectrum.

5. The method of claim 1, wherein the coding material is colored or tinted to match a color of the item at the coding site.

6. The method of claim 1, wherein the coding material is applied to the coding site as a paint.

7. The method of claim 5, wherein the paint is colored or tinted to match a paint of the item at the coding site.

8. The method of claim 1, wherein the coding material is visually imperceptible.

9. The method of claim 1, further comprising forming a small bore in the item, and wherein applying the coding material includes filling the bore with the coding material.

10. The method of claim 1, further comprising applying the coding material to a second coding site on the item, wherein authenticating the item further comprises classifying the item as not authentic when the coding material is not present at the second coding site.

11. The method of claim 1, wherein the item is selected from the group consisting of: sculptures, paintings, drawings, textiles, pottery, jewelry, utensils, weapons, currency, musical instruments, clothing, skeletons, books, and astronomical artifacts.

12. The method of claim 1, further comprising selecting a location of the coding site on the item and storing the location of the coding site.

13. The method of claim 13, wherein said selecting and storing the location of the coding site are performed by a trusted authority, wherein the trusted authority is not an owner or custodian of the item.

14. A method for authenticating an item, the method comprising:
selecting a location of a coding site on the item and storing the location of the coding site;
selecting a coding material including at least one transition metal, wherein the coding material includes a combination of chemical elements.
obtaining an original spectrum of the coding material using an X-ray fluorescence spectroscopy device, the combination of chemical elements resulting in the authentication spectrum;
applying the coding material to the coding site;
obtaining an authentication spectrum at the coding site using an X-ray fluorescence spectroscopy device; and
authenticating the item by classifying the item as authentic when the coding material is present at the coding site and the authentication spectrum matches the x-ray fluorescence spectrum of the coding material and classifying the item as not authentic when the coding material is not present at the coding site or the authentication spectrum does not match the x-ray fluorescence spectrum of the coding material.

15. The method of claim 14, further comprising applying the coding material to a second coding site on the item, wherein authenticating the item further comprises classifying the item as not authentic when the coding material is not present at the second coding site

16. The method of claim 14, wherein the item is selected from the group consisting of: sculptures, paintings, drawings, textiles, pottery, jewelry, utensils, weapons, currency, musical instruments, clothing, skeletons, books, and astronomical artifacts.

17. The method of claim 14, wherein the at least one transition metal is selected from a transition metal in groups 3 through 12 of the periodic table.

18. The method of claim 16 wherein the at least one transition metal is a rare-earth metal.

19. The method of claim 14, wherein the coding material is visually imperceptible.

20. A method for authenticating an item, comprising:
selecting a coding site on the item;
storing a location of the coding site;
selecting a coding material including at least one transition metal;
obtaining an original spectrum of the coding material using an X-ray fluorescence spectroscopy device;
storing the original spectrum;
applying the coding material to the coding site; and
authenticating the item by
accessing the location of the coding site and the original spectrum,
determining whether the coding material is present at the coding site,
obtaining an authentication spectrum of the coding material using an X-ray fluorescence spectroscopy device,
comparing the authentication spectrum to the original spectrum,
classifying the item as authentic when the coding material is present at the coding site and the authentication spectrum matches the original spectrum, and
classifying the item as not authentic when the coding material is not present at the coding site or the authentication spectrum does not match the original spectrum.
